(19) United States
(12) Patent Application Publication
(10) Pub. No.: US 2017/0148394 A1
(43) Pub. Date: May 25, 2017

(54) SYSTEM AND METHOD FOR CONTROLLING DYNAMIC BACKLIGHT SOURCE OF ELED

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventors: Jianbin GAO, Tianjin (CN); Xianlei MENG, Tianjin (CN); Changjia FU, Tianjin (CN); Zhishuai JIA, Tianjin (CN); Jinnan ZHANG, Tianjin (CN)

(21) Appl. No.: 15/242,918

(22) Filed: Aug. 22, 2016

Related U.S. Application Data
(63) Continuation of application No. PCT/CN2016/082529, filed on May 18, 2016.

(30) Foreign Application Priority Data
Nov. 23, 2015 (CN) 2015108232656

(51) Int. Cl. G09G 3/34; G02F 1/1368; G02F 1/137; G09G 3/36

(52) U.S. Cl. CPC G09G 3/3413; G09G 3/36; G02F 1/1368; G02F 1/137; G09G 2310/0237; G09G 2310/08; G09G 2320/0271; G09G 2320/0646

(57) ABSTRACT

Disclosed are a system and method for controlling dynamic backlight source of ELED, wherein the backlight source signal processing circuit is used for obtaining SOC picture signals, decoding the SOC picture signals into light and dark signals, and transmitting the light and dark signals to the optical processing board; the optical processing board is provided with a transparent substrate; the optical processing board receives the light and dark signals, and controls the on and off states of light valves on the transparent substrate in real time according to the light and dark signals; the backlight source driving board provides electric power for the backlight source signal processing circuit and the static plane backlight source; and the static plane backlight source is used for providing a dynamic light source for a liquid crystal display panel through the transparent substrate. Thus the disclosure realizes a dynamic picture display.

This application is a continuation of International Application No. PCT/CN2016/082529, filed on May 18, 2016, which is based upon and claims priority to Chinese Patent Application No. 201510823265.6, filed on Nov. 23, 2015, the entire contents of which are incorporated herein by reference.

### TECHNICAL FIELD

The disclosure relates to the field of dynamic backlight source control technology, and particularly to system and method for controlling dynamic backlight source of ELED.

### BACKGROUND

At present, along with the fact that the thickness of a mainstream liquid crystal television is increasingly thin, the size is increasingly large, and the requirement on color and contrast of the television is increasingly high, a DLED (Direct type LED) dynamic backlight source control system appears, but an ELED (Edge type LED) backlight source optical control system is blank in the industry.

In the industry, there are mainly two types of television OC (Open Cell), i.e., hard-screen television OC and soft-screen television OC, wherein the hard-screen television OC, although its picture quality is higher than that of the soft-screen television OC due to self-structure characteristics, is likely to generate light leakage to make many complete machine factories shrink back at the sight of this defect.

In the industry, the dynamic backlight source control of an existing DLED controls a backlight source only through regional control of LED lamps, and due to self-structure limitation, the televisions with DLED are thicker than those with ELED.

At present, for the traditional backlight LED system, a static backlight source includes backlight source driving board and a static plane backlight source. The traditional ELED backlight source only acts below the OC through a static plane light source, and the brightness of a picture is controlled by the OC itself, so that the backlight source cannot be dynamically controlled.

### SUMMARY

In order to overcome the defect in the prior art that a backlight source cannot be dynamically controlled, the embodiment of the disclosure provides an ELED dynamic backlight source control system according to one aspect of the embodiment of the disclosure.

The ELED dynamic backlight source control system provided by the embodiment of the present disclosure includes: a backlight source signal processing circuit, an optical processing board, a backlight source driving board and a static plane backlight source,
wherein the backlight source signal processing circuit is used for obtaining SOC (system on a chip) picture signals, decoding the SOC picture signals into light and dark signals, and transmitting the light and dark signals to the optical processing board;
the optical processing board is provided with a transparent substrate, the transparent substrate is provided with a light valve circuit used for controlling light penetration, and the transparent substrate is arranged between the static plane backlight source and the liquid crystal display panel; the optical processing board receives the light and dark signals, and controls the on and off states of light valves on the transparent substrate in real time according to the light and dark signals;
the backlight source driving board is connected with the backlight source signal processing circuit and the static plane backlight source, and provides electric power for the backlight source signal processing circuit and the static plane backlight source; and
the static plane backlight source is used for providing a dynamic light source for the liquid crystal display panel by transmitting the transparent substrate.

In the above technical solution, the light and dark signals include light signals and/or dark signals. The optical processing board controls a light valve at a position corresponding to the light signals to be in an on state, and a light valve at a position corresponding to the dark signals to be in an off state.

In the above technical solution, the SOC picture signals include RGB signals and/or grey level signals. The backlight source signal processing circuit converts a signal of which the RGB values are smaller than preset RGB threshold values in the RGB signals and/or a signal of which the gradation value is smaller than a preset gradation value in the grey level signals into dark signals.

In the above technical solution, the backlight source signal processing circuit includes a filter circuit and/or a signal converting circuit. The filter circuit is used for filtering the SOC picture signals; and the signal converting circuit is used for converting the SOC picture signals into light and dark signals.

In the above technical solution, the system also includes a liquid crystal display panel. The liquid crystal display panel is used for displaying a final picture according to the SOC picture signals and the dynamic light source.

In the above technical solution, the liquid crystal display panel is a TFT-LCD (Thin Film Transistor Liquid Crystal Display).

In the above technical solution, the liquid crystal display panel integrates a TCON (Timer Control Register), which is used for converting the SOC picture signals into working voltages, working signals and/or timing signals needed by the liquid crystal display panel.

In the above technical solution, the system also includes an SOC. The SOC is connected with the backlight source signal processing circuit and the TCON respectively, and is used for providing SOC picture signals for the backlight source signal processing circuit and the TCON respectively.

Based on the same inventive concept, the disclosure also provides a dynamic backlight source control method, comprising:
receiving SOC picture signals, and decoding the SOC picture signals into light and dark signals;
controlling the on and off states of light valves on a transparent substrate of an optical processing board in real time according to the light and dark signals, wherein the transparent substrate is arranged between a static plane backlight source and a liquid crystal display panel; and
controlling the static plane backlight source to provide a dynamic light source for the liquid crystal display panel by transmitting the transparent substrate, and instructing the liquid crystal display panel to display a final picture according to the SOC picture signals and the dynamic light source.

In the above technical solution, decoding the SOC picture signals into light and dark signals includes:
obtaining RGB signals and/or grey level signals in the SOC picture signals; and
converting a signal of which the RGB values are smaller than preset RGB threshold values in the RGB signals and/or a signal of which the gradation value is smaller than a preset gradation value in the grey level signals into dark signals.

According to the ELED dynamic backlight source control system and control method provided by the disclosure, the SOC picture signals are converted into the light and dark signals, then light transmitted from the static plane backlight source to the liquid crystal display panel can be controlled through the transparent substrate on the optical processing board, the optical processing board and the static plane backlight source form a dynamic backlight source, and the liquid crystal display panel restores a finally displayed picture according to the dynamic light source and the SOC picture signals, so that dynamic display of the picture is achieved. The dynamic backlight source can provide black signals or local black signals for the liquid crystal display panel (LCD) under a black picture or a local black picture to ensure that light cannot irradiate on the lower surface of the liquid crystal display panel, so that even though the LCD has a local stress, the problem of light leakage cannot be generated; and meanwhile, undesirable light leakage also cannot be experienced on the expression of a whole picture.

Other features and advantages of the disclosure will be stated in the follow-up description, and partially become apparent in the description, or will be understood by implementation of the disclosure. The object and other advantages of the disclosure can be achieved and obtained through structures particularly specified in the written description, claims, and accompanying drawings.

Hereinafter, the technical solution of the disclosure is further described in details through the accompanying drawings and embodiments.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a first diagram of a structure of the ELED dynamic backlight source control system in an embodiment of the disclosure;

FIG. 2 is a Second diagram of a structure of the ELED dynamic backlight source control system in an embodiment of the disclosure;

FIG. 3 is a flow diagram of the ELED dynamic backlight source control method in an embodiment of the disclosure.

### DETAILED DESCRIPTION

Hereinafter, with reference to the accompanying drawings, the specific embodiments of the disclosure are described in details, and it will be appreciated that the protection scope of the disclosure is not limited by the specific embodiment.

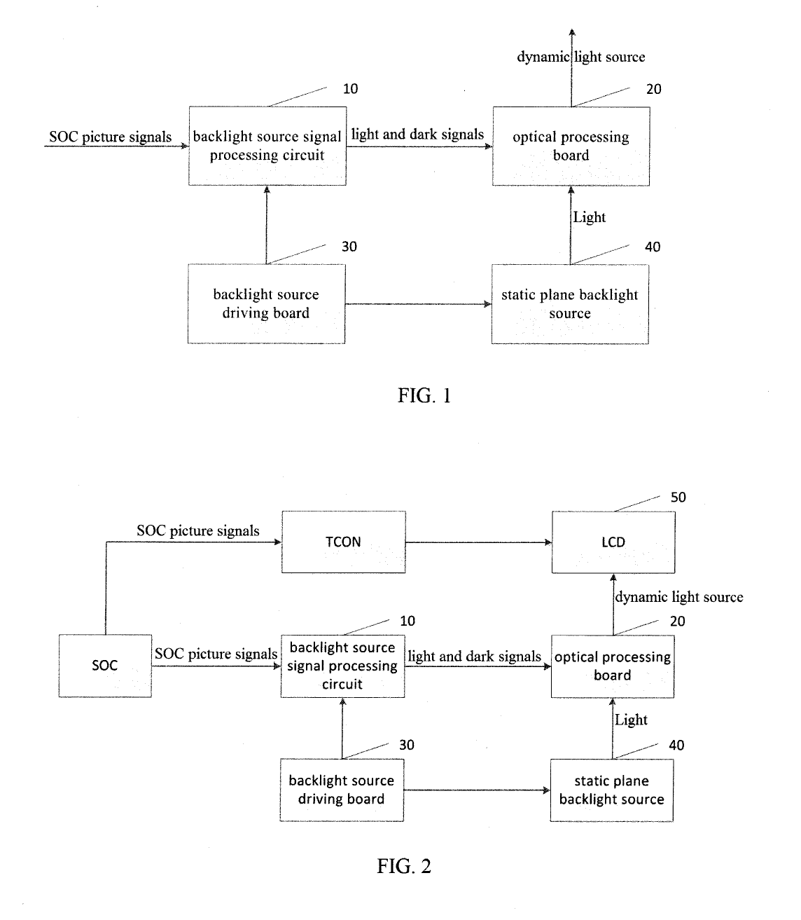

According to the embodiment of the disclosure, an ELED dynamic backlight source control system is provided. FIG. 1 is a schematic diagram of a structure of the system, which specifically includes a backlight source signal processing circuit 10, an optical processing board 20, a backlight source driving board 30 and a static plane backlight source 40.

Specifically, the backlight source signal processing circuit 10 is connected with an SOC (system on a chip), and is used for obtaining SOC picture signals sent by the SOC, decoding the SOC picture signals into light and dark signals and transmitting the light and dark signals to the optical processing board 20 at the same time. The SOC picture signals include RGB signals and/or grey level signals.

In the embodiment of the disclosure, the light and dark signals include light signals and/or dark signals, wherein the backlight source signal processing circuit converts a RGB signal of which the RGB values are smaller than preset RGB threshold in the RGB signals into a dark signal, or converts a grey level signal of which the gradation value is smaller than a preset gradation value in the grey level signals into a dark signal, wherein the RGB values include an R value, a G value and a B value, a signal of which the three values are smaller than a certain preset value can be converted into a dark signal, or a signal of which the sum of the three values is smaller than a certain preset value can be converted into a dark signal. The backlight source signal processing circuit converts the rest of the signals into light signals, and the RGB values of the rest of the signals exceed a certain value and make a human eye sense a color picture. Meanwhile, it should be noted that the backlight source signal processing circuit 10 takes pixel as a unit, and decodes the SOC picture signals into the light and dark signals, that is to say, each pixel corresponds to one light signal or one dark signal.

The optical processing board 20 is provided with a transparent substrate, and a light valve circuit capable of controlling light penetration is arranged on the transparent substrate, the light valve circuit is used for controlling the on and off of the light emitted from the static plane backlight source to the liquid crystal display panel. The transparent substrate is arranged between the static plane backlight source 40 and the liquid crystal display panel. The optical processing board 20 receives the light and dark signals, and controls the on and off states of light valves on the transparent substrate. Specifically, the optical processing board 20 controls a light valve at a position corresponding to the light signals to be in an on state, and controls a light valve at a position corresponding to the dark signals to be in an off state.

For example, when a light valve on the transparent substrate is in the on state, the light emitted by the static plane backlight source 40 can be emitted to the liquid crystal display panel through the light valve. When a signal corresponding to a certain light valve on the transparent substrate is converted into a dark signal, the light valve is set to be in an off state, and at this moment, the light valve on the transparent substrate blocks the light emitted by the static plane backlight source 40, that is to say, a corresponding position on the liquid crystal display panel shows a black picture.

The existing common backlight source is a continuous surface light source, so the liquid crystal display panel (LCD) can only realize a black field signal through its own circuit. An IPS hard screen on the market, because of the particularity of its electrical principle structure, will have abnormal display of a picture, i.e. originally a pure black picture, but revealing light, called light leakage, under a black picture when the LCD itself is subjected to a stress of itself or from the outside. In the embodiment of the disclosure, the dynamic backlight source, under a black picture or a local black picture, can provide a black signal or a local black signal for the LCD, so that the light cannot irradiate on the lower surface of the liquid crystal display panel, and the problem of light leakage cannot be generated even though the LCD has a local stress. Meanwhile, undesirable light leakage also cannot be experienced on the expression of a whole picture.

The backlight source driving board 30 is connected with the backlight source signal processing circuit 10 and the static plane backlight source 40, and provides electric power for the backlight source signal processing circuit 10 and the static plane backlight source 40. The static plane backlight source 40 is used for providing a dynamic light source for the liquid crystal display panel by transmitting the transparent substrate of the optical processing board 20.

According to the ELED dynamic backlight source control system provided by the embodiment of the disclosure, the SOC picture signals are converted into the light and dark signals, then the light transmitted from the static plane backlight source to the liquid crystal display panel can be controlled through the transparent substrate on the optical processing board, the optical processing board and the static plane backlight source form a dynamic backlight source, and the liquid crystal display panel restores a finally displayed picture according to the dynamic light source and the SOC picture signals, so that dynamic display of the picture is achieved.

In one embodiment, the backlight source signal processing circuit 10 includes a filter circuit and/or a signal converting circuit, wherein the filter circuit is used for filtering the SOC picture signals, and the signal converting circuit is used for converting the SOC picture signals into light and dark signals.

Specifically, the filter circuit filters out light signals and only reserves the dark signals, and a corresponding light valve on the transparent substrate is controlled to be in an off state, while the rest of the light valves are kept in an on state, according to the reserved dark signals. The signal converting circuits can directly convert the SOC picture signals into the light signals and/or the dark signals.

In one embodiment, as shown in FIG. 2, the device also includes a liquid crystal display panel 50 which is used for displaying a final picture according to the SOC picture signals and a dynamic light source.

Specifically, the liquid crystal display panel 50 can be a TFT-LCD (Thin Film Transistor Liquid Crystal Display) which makes use of thin film transistors to generate voltage to control liquid crystal turning.

The liquid crystal display panel 50 integrates a TCON or is externally provided with the TCON (Timer Control Register). The TCON is used for converting the SOC picture signals into working voltages, working signals and/or timing sequence signals needed by the liquid crystal display panel. Specifically, various timing control signals needed by a circuit can be integrated according to input clock signals.

In one embodiment, as shown in FIG. 2, the device also includes an SOC which is connected with the backlight source signal processing circuit 10 and the TCON respectively, and is used for providing SOC picture signals for the backlight source signal processing circuit 10 and the TCON respectively.

According to the ELED dynamic backlight source control system provided by the embodiment of the disclosure, the SOC picture signals are converted into the light and dark signals, then the light transmitted from the static plane backlight source to the liquid crystal display panel can be controlled through the transparent substrate on the optical processing board, the optical processing board and the static plane backlight source form a dynamic backlight source, and the liquid crystal display panel restores a finally displayed picture according to the dynamic light source and the SOC picture signals, so that dynamic display of the picture is achieved. The dynamic backlight source can provide black signals or local black signals for the liquid crystal display panel (LCD) under a black picture or a local black picture to ensure that light cannot irradiate on the lower surface of the liquid crystal display panel, so that even though the LCD has a local stress, the problem of light leakage cannot be generated; and meanwhile, undesirable light leakage also cannot be experienced on the expression of a whole picture.

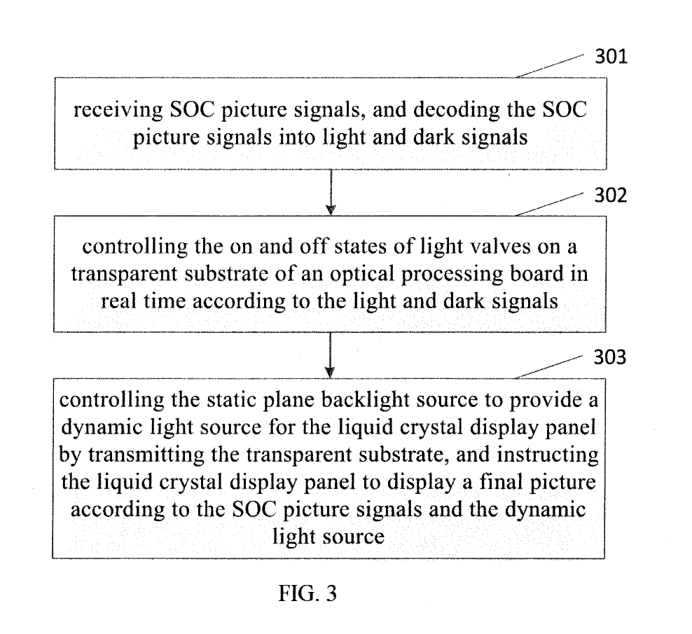

Based on the same inventive concept, an embodiment of the disclosure also provides an ELED dynamic backlight source control method. As shown in FIG. 3, the method includes the steps 301-303:
step 301: receiving SOC picture signals, and decoding the SOC picture signals into light and dark signals;
step 302: controlling the on and off states of light valves on a transparent substrate of an optical processing board in real time according to the light and dark signals, wherein the transparent substrate is arranged between a static plane backlight source and a liquid crystal display panel; and
step 303: controlling the static plane backlight source to provide a dynamic light source for the liquid crystal display panel by transmitting the transparent substrate, and instructing the liquid crystal display panel to display a final picture according to the SOC picture signals and the dynamic light source.

Wherein, the method is based on the above-mentioned ELED dynamic backlight control system.

In one embodiment, decoding the SOC picture signals into light and dark signals in step 101 includes steps A1-A2:
step A1, obtaining RGB signals and/or grey level signals in the SOC picture signals; and
step A2, converting a RGB signal of which the RGB values are smaller than preset RGB threshold in the RGB signals and/or a grey level signal of which the gradation value is smaller than a preset gradation value in the grey level signals into dark signals.

According to the ELED dynamic backlight source control system and control method provided by the embodiment of the disclosure, the SOC picture signals are converted into the light and dark signals, then the light transmitted from the static plane backlight source to the liquid crystal display panel can be controlled through the transparent substrate on the optical processing board, the optical processing board and the static plane backlight source form a dynamic backlight source, and the liquid crystal display panel restores a finally displayed picture according to the dynamic light source and the SOC picture signals, so that dynamic display of the picture is achieved. The dynamic backlight source can provide black signals or local black signals for the liquid crystal display panel (LCD) under a black picture or a local black picture to ensure that light cannot irradiate on the lower surface of the liquid crystal display panel, so that even though the LCD has a local stress, the problem of light leakage cannot be generated; and meanwhile, undesirable light leakage also cannot be experienced on the expression of a whole picture.

The present disclosure may have various embodiments in different forms, the technical solution of the present invention is illustrated above by taking FIG. 1-FIG. 3 as examples in combination with the accompanying drawings, and this does not mean that the specific examples employed by the present disclosure can only be limited in specific processes or embodiment structures; and it will be appreciated by those of ordinary skill in the art that the above-mentioned specific embodiments are merely some examples of a variety of preferred usages, and any embodiment embodying the claims of the present disclosure should be in the protection scope claimed by the technical solution of the present disclosure.

Finally, it should be noted that what mentioned above is only a preferred embodiment of the present disclosure, and is not used for limiting the present disclosure; and although the present disclosure is described in details with reference to the above-mentioned embodiment, those skilled in the art still can modify the technical solution stated in the above-mentioned embodiment, or equivalently substitute part of the technical features therein. Any modification, equivalent substitution, improvement, etc. made within the spirit and principle of the present disclosure shall be incorporated in the protection scope of the present disclosure.

What is claimed is:

1. An ELED dynamic backlight source control system, comprising: a backlight source signal processing circuit, an optical processing board, a backlight source driving board and a static plane backlight source, wherein
the backlight source signal processing circuit is used for obtaining SOC picture signals, decoding the SOC picture signals into light and dark signals, and transmitting the light and dark signals to the optical processing board;
the optical processing board is provided with a transparent substrate, the transparent substrate is provided with a light valve circuit which is used for controlling light penetration, and the transparent substrate is arranged between the static plane backlight source and the liquid crystal display panel; the optical processing board receives the light and dark signals, and controls the on and off states of light valves on the transparent substrate in real time according to the light and dark signals;
the backlight source driving board is connected with the backlight source signal processing circuit and the static plane backlight source, and provides electric power for the backlight source signal processing circuit and the static plane backlight source; and
the static plane backlight source is used for providing a dynamic light source for a liquid crystal display panel by transmitting the transparent substrate.

2. The system according to claim 1, wherein, the light and dark signals comprise light signals and/or dark signals; and
the optical processing board controls a light valve at a position corresponding to the light signals to be in an on state, and a light valve at a position corresponding to the dark signals to be in an off state.

3. The system according to claim 2, wherein, the SOC picture signals comprise RGB signals and/or grey level signals; and
the backlight source signal processing circuit converts a RGB signal of which the RGB values are smaller than preset RGB threshold in the RGB signals and/or a grey level signal of which the gradation value is smaller than a preset gradation value in the grey level signals into dark signals.

4. The system according to claim 1, wherein, the backlight source signal processing circuit comprises a filter circuit and/or a signal converting circuit;
the filter circuit is used for filtering the SOC picture signals; and
the signal converting circuit is used for converting the SOC picture signals into light and dark signals.

5. The system according to claim 1, further comprising: a liquid crystal display panel, wherein the liquid crystal display panel is used for displaying a final picture according to the SOC picture signals and the dynamic light source.

6. The system according to claim 5, wherein, the liquid crystal display panel is a TFT-LCD (Thin Film Transistor Liquid Crystal Display).

7. The system according to claim 5, wherein, the liquid crystal display panel integrates a TCON (Timer Control Register), which is used for converting the SOC picture signals into working voltages, working signals and/or timing sequence signals needed by the liquid crystal display panel.

8. The system according to claim 7, further comprising: an SOC, wherein,
the SOC is connected with the backlight source signal processing circuit and the Timer Control Register respectively, and is used for providing the SOC picture signals for the backlight source signal processing circuit and the Timer Control Register respectively.

9. An ELED dynamic backlight source control method, comprising:
receiving SOC picture signals, and decoding the SOC picture signals into light and dark signals;
controlling the on and off states of light valves on a transparent substrate of an optical processing board in real time according to the light and dark signals, wherein the transparent substrate is arranged between a static plane backlight source and a liquid crystal display panel; and
controlling the static plane backlight source to provide a dynamic light source for the liquid crystal display panel by transmitting the transparent substrate, and instructing the liquid crystal display panel to display a final picture according to the SOC picture signals and the dynamic light source.

10. The method according to claim 9, wherein, decoding the SOC picture signals into light and dark signals comprises:
obtaining RGB signals and/or grey level signals in the SOC picture signals; and
converting a signal of which the RGB values are smaller than preset RGB threshold values in the RGB signals and/or a signal of which the gradation value is smaller than a preset gradation value in the grey level signals into dark signals.
